(19) United States
(12) Patent Application Publication
(10) Pub. No.: US 2008/0213027 A1
(43) Pub. Date: Sep. 4, 2008

(54) Imaging device

(76) Inventors: Robert M. Yraceburu, Camas, WA (US); Angela Chen Krauskopf, Camas, WA (US); Stuart D. Spencer, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/712,607

(22) Filed: Mar. 1, 2007

(51) Int. Cl. B41L 47/02

(52) U.S. Cl. 400/648

(57) ABSTRACT

An imaging device includes a support platen having vacuum hold down recesses and a screen positioned on the platen.

### BACKGROUND

Imaging devices, such as printers, may include support structures, such as platens, that may secure a sheet of print media thereon by use of vacuum pressure. It may be desirable to increase the vacuum pressure hold down efficiency and to reduce problems associated with contamination of the platen, without increasing the manufacturing cost or power requirements of the platen.

### BRIEF DESCRIPTION OF THE DRAWINGS

FIG. 1 is a schematic view of one example embodiment of an imaging device.

FIG. 2 is an isometric detailed view of one example embodiment of a platen.

FIG. 3 is a front detailed view of one example embodiment of a platen screen.

### DETAILED DESCRIPTION OF THE DRAWINGS

The ability to hold down a sheet of print media on a vacuum platen surface may depend at least in part on the topology of the surface. It may be desirable that the surface allow for a large airflow in critical areas of the surface, such as at the leading and trailing edges of the media, allow restricted airflow in other areas so that the system power budget is not exceeded for overall vacuum requirements, and should be resistant to plugging by contaminants such as ink aerosol and paper dust. It may also be desirable that the topology be manufacturable at a low cost.

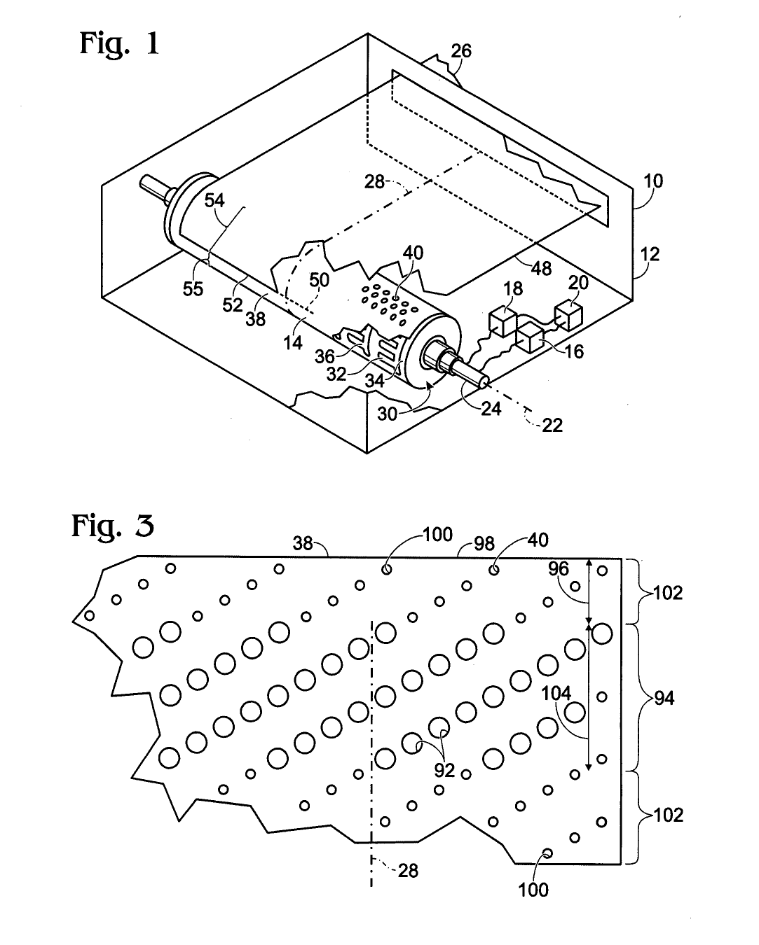

FIG. 1 is a schematic view of one example embodiment of an imaging device 10, such as a printer. Imaging device 10 may include a housing 12 that encloses a support structure, such as a platen 14, which may be in the shape of a cylindrical drum. Housing 12 may further enclose a vacuum system 16 (shown schematically) connected to platen 14, a power system 18 (shown schematically), such as a motor, connected to platen 14, and a control system 20, such as computer hardware and software, connected to vacuum system 16 and power system 18. Control system 20 may control power system 18 to rotate platen 14 about a rotational axis 22 extending along a drive shaft 24 such that a sheet of print media 26 is fed along an axis of sheet media travel 28 that bends around platen 14.

Vacuum system 16 may be operatively connected to platen 14, such as to an interior cavity 30 of platen 14, and therethrough to a vacuum structure 32 on an exterior surface 34 of platen 14. Vacuum structure 32 on platen 14 may include an array of recesses 36 in exterior surface 34 of platen 14 and a vacuum hold down screen 38 positioned on exterior surface 34 of platen 14. Screen 38 may extend around platen 14 and may include an array of apertures 40 (in FIG. 1 only a few apertures of array 40 are shown for ease of illustration) that extend along screen 38.

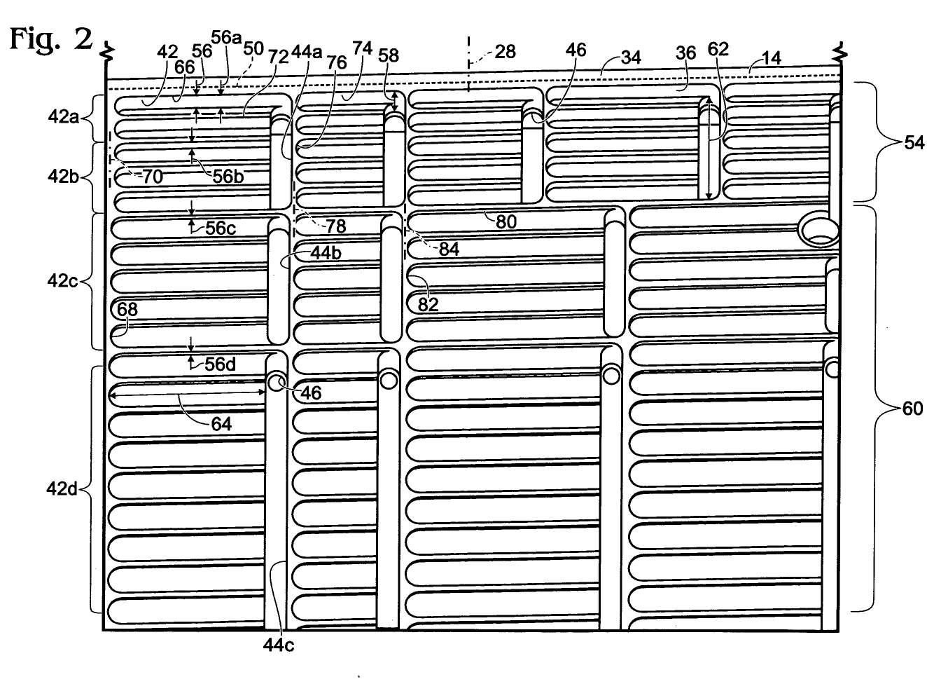

FIG. 2 is an isometric detailed view of one example embodiment of platen 14 including array of recesses 36 positioned in exterior surface 34 of platen 14. Platen 14 may be cylindrical in shape so that the grooves may approach a horizon line as shown in FIG. 2. Array of recesses 36 may include a plurality of grooves 42 wherein individual sets of grooves, 42a, 42b, 42c and 42d, for example, are operatively connected to one of a plurality of channels 44, such as individual channels 44a, 44b and 44c, for example. Each channel 44 may include an aperture 46 that extends through platen 14 to interior cavity 30 (FIG. 1) such that grooves 42 and channels 44 are operatively connected to vacuum system 16 (FIG. 1) via aperture 46. Each of channels 44 may be positioned parallel to axis of sheet media travel 28 and each of grooves 42 may be positioned perpendicular to axis of sheet media travel 28.

Referring to FIGS. 1 and 2, platen 14 may define a leading edge position 50 wherein each individual sheet of print media 26 (only one sheet 26 is shown in FIG. 1 for ease of illustration) may be fed sequentially onto platen 14 with its leading edge 52 positioned at leading edge position 50 of platen 14. Although leading edge position 50 is shown upstream of the grooves, it may be optimal for the leading edge position 50 to be in line with the grooves or even slightly downstream of the grooves. Platen 14 may also define a leading edge region 54 extending rearwardly, such as upstream from, in the particular example embodiment shown, leading edge position 50. Leading edge region 54 may be defined as extending at most one quarter of a lineal length of the platen from leading edge position 50 of the platen, and may extend 40 mm or less from leading edge position 50 of platen 14. Grooves 42 of platen 14 positioned within leading edge region 54 may define a depth 56 that may be greater than a depth, respectively, of grooves 42 positioned in on a remainder 60 of platen 14, i.e., positioned on platen 14 outside of leading edge region 54. In one example embodiment, grooves 42a have a depth 56a of 3 mm, grooves 42b have a depth 56b of 2 mm, and grooves 42c and 42d have a depth 56c and 56d, respectively, of 1 mm. Channels 44 may define a depth 58 in a range of 2 mm to 6 mm, for example, or any other depth as may be desirable.

Use of grooves greater than a depth of 1 mm in a small region, i.e., leading edge region 54, may not prohibitively increase the cost of manufacturing platen 14 because a majority of grooves in the platen may have a depth of approximately 1 mm. In particular, grooves having a depth of approximately 1 mm may be manufactured by a single pass manufacturing process wherein grooves having a depth of greater than 1 mm may be manufactured in two or more passes, thereby increasing production costs. By reducing the number of grooves manufactured with this more timely multi-pass manufacturing process, the overall cost of the platen is reduced when compared to a platen manufactured with all grooves having a depth greater than 1 mm.

The greater depth 56a and 56b of grooves 42a and 42b positioned within leading edge region 54, when compared with the depth 56c and 56d of grooves 42c and 42d positioned outside of leading edge region 54, allows more ink and dust from media or other airborne particles to accumulate and form taller stalagmites within leading edge region 54 than in a remainder 60 of platen 14, thereby reducing the occurrence of stalagmites reaching a height wherein they may contact sheet 26 and reduce the print quality of ink printed on sheet 26.

Ink and dust accumulation may occur in large concentrations within leading edge region 54 when compared to remainder 60 of platen 14 because the apertures in remainder 60 of platen 14 are normally valved closed when media is not present. Accordingly, dried ink and dust stalagmites of an undesired height may be more likely to occur in leading edge region 54, wherein such stalagmites of an undesired height may extend upwardly beyond exterior surface 34 of platen 14 and contact a sheet of print media 26 during printing. Such contact may damage the sheet 26 or reduce the print quality of an image printed on sheet 26. The stalagmites may also clog apertures 40 of platen screen 38, thereby reducing the vacuum pressure effectiveness of the screen 38. However, manufacturing platen 14 with deeper grooves covering the entire exterior surface 34 of platen 14 may prohibitively increase the manufacturing costs of platen 14, as discussed above. Accordingly, platen 14 having grooves 42 in a leading edge region 54 of a depth 56, greater than a depth of grooves outside leading edge region 54, enhances print quality and media hold-down of the printing device 10 while increasing by a small amount the manufacturing costs of platen 14. Moreover, platen 14 having grooves 42 and channels 44 in a leading edge region 54 of a depth 56, 58, greater than a depth of grooves and channels outside leading edge region 54, provides less airflow restriction and better distribution of vacuum pressure under the leading edge region of the sheet of print media 26, thereby increasing the effectiveness of the vacuum system.

Still referring to FIG. 2, channels 44a in leading edge region 54 may have a length 62 of approximately 30 mm, wherein length 62 is measured parallel to sheet media travel axis 28, and wherein channels 44a extend through leading edge region 54. Grooves 42a, 42b, 42c and 42d may all have a length 64 of approximately 40 mm, wherein length 64 is measured perpendicular to sheet media travel axis 28, and wherein grooves 42a-42d may collectively define a column 66 of grooves. The grooves may each define a length less than half of a width of platen 14 measured perpendicular to axis 28, and in the embodiment shown each define a length approximately less than one quarter of a width of platen 14 measured perpendicular to axis 28. Each groove 42 of column 66 may be spaced from its adjacent groove by a distance of approximately 1 mm, which may define a rib 72. Column of grooves 66 may extend circumferentially around platen 14 and may define an edge region 68 that is aligned with a larger sheet edge position 70. Larger sheet edge position 70 may be a position wherein an edge of a larger sheet (not shown) of print media 26, such as a 9×11 inch larger sheet, may be positioned when fed to platen 14. Another column of grooves 74 may define an edge region 76 that may be aligned with a large sheet edge position 78. Large sheet edge position 78 may be a position wherein an edge of a large sheet (not shown) of print media 26, such as a 8¼×11¾ (A4) inch sheet, may be positioned when fed to platen 14. Another column of grooves 80 may define an edge region 82 that is aligned with a small sheet edge position 84. Small sheet edge position 84 may be a position wherein an edge of a small sheet (not shown) of print media 26, such as a 8×11 inch sheet, may be positioned when fed to platen 14. Accordingly, the edge regions 68, 76, 82 of the individual groove columns 66, 74, 80, may be aligned with an edge position 70, 78, 84, on platen 14 of standard sheets of print media 26 such that the standard sheets 26 are efficiently held down on platen 14 by vacuum pressure through grooves 42 and channels 44 along an edge region 48 (FIG. 1) of a variety of standard sized sheets 26 of print media.

Alignment of the edge regions 68, 76, 82 of the groove columns 66, 74, 80 just inside a position where an edge 48 (FIG. 1) of a standard sheet 26 of print media will be positioned may increase the probability that the standard sized sheet 26 will completely cover a vacuum groove 42 and/or channel 44, without leaving a portion of a channel 42 or a groove 44 uncovered. By completely covering grooves 42 and channels 44 with a sheet of print media 26, platen 14 will firmly hold down a side edge region of a sheet of print media 26, and therefore the entire sheet, that is fed to platen 14. Leaving portions of a groove 42 or a channel 44 uncovered may allow vacuum pressure to be reduced at the uncovered groove or channel, thereby reducing the vacuum pressure and efficiency of the system. In other words, by manufacturing platen 14 with grooves and channels positioned to be completely covered by standard print media sheet sizes, the efficiency of vacuum system 16 may be increased without adding a larger powered vacuum system to the imaging device 10. Manufacturing platen 14 with grooves 42 and channels 44 of differing lengths allows platen 14 to accommodate and hold down a variety of different sizes and thicknesses of sheets of print media 26 without changing out the platen 14.

As disclosed above, deeper grooves 42 may be utilized in leading edge region 54 of platen 14. A similar pattern of deeper grooves may be utilized in a trailing edge region 55 (FIG. 1) of platen 14 to produce similar advantages in the trailing edge region of the platen. The grooves 42 and channels 44 in trailing edge region 55 may be the same size and placement as those shown in leading edge region 54.

As shown in FIG. 2, the grooves 42 positioned within leading edge region 54 may have a length 64 of a different size than grooves 42 positioned in a remainder 60 of platen 14 because less vacuum airflow may be required to hold down the middle of a sheet of media to the platen. A greater number of apertures and channels, and thus shorter length grooves, may be present in the more critical leading and trailing edge regions to allow for more media sizes to seal up on. The reduced number of apertures and channels in the middle section may allow for better use of vacuum power budget.

The groove 42 and channel 44 pattern as disclosed herein may be optimized for standard sizes so as to seal the channels and grooves for maximum vacuum pressure. In other words, standard sizes of print media may be aligned on the platen with their edge region positioned just over a groove column edge so as to seal the groove column and enhance the vacuum pressure of the system that holds the print media down. Accordingly, the system as disclosed provides for secure hold down of heavier weight media, such as 220 gsm weight media, when compared to prior art platens. The groove and channel pattern as shown may also accommodate non-standard sizes. In particular, although an edge of a non-standard media sheet may not be aligned with the edge of a groove column such that the non-standard media size sheet may not seal up the column of grooves on the platen as disclosed, the multi-column pattern of grooves may still allow the vacuum system to hold down lighter weight media, such as up to 120 gsm.

FIG. 3 is a front detailed view of one example embodiment of a platen screen 38. Screen 38 includes an array of apertures 40 which may include apertures 92 in a leading edge region 94 spaced a distance 96 from a leading edge position 98 of screen 38, and including apertures 100 in a remaining portion 102 of screen 38. In the example embodiment shown, remainder 102 of screen 38 extends both upstream and down stream of leading edge region 94. Additionally, in the example embodiment shown, apertures 92 in leading edge region 94 have a diameter of approximately 1.47 mm and apertures 100 in remaining portions 102 of screen 38 have a diameter of approximately 0.83 mm, such that apertures 92 have a surface area at least two times larger, and approximately three times larger, than a surface area of apertures 100. Distance 96 from leading edge position 98 to leading edge region 94 may be at least 2 mm, and may be approximately 4 mm, and leading edge region 94 may define a length 104 measured parallel to axis 28 of approximately 8 mm, and at most 20 mm from leading edge position 98 of screen 38.

Apertures 92 in leading edge region 94 may be larger than apertures 100 in remaining portions 102 of screen 38 such that the larger apertures 92 allow a larger vacuum force in leading edge region 94, such that a leading edge 52 (FIG. 1) of a sheet of print media 26 fed to platen 14 will be held down at the leading edge region 94 with a strong vacuum pressure. Moreover, larger aperture sizes in leading edge region 94 may reduce clogging of the apertures 92 by contaminants during the printing process. However, if larger sized apertures, 1.47 mm for example, are utilized across the entire surface of screen 38, then such large apertures may reduce the effectiveness of vacuum system 16, may leave the aperture's thermal imprint on sheet of print media 26, may disrupt the trajectory of ink droplets as well as pull ink aerosol particles onto the platen, and may increase the probability that stripper/scraper fingers of a media ejection system (not shown) may fall into or become trapped in the screen apertures. Accordingly, by manufacturing screen 38 with large apertures only in leading edge region 94, the vacuum efficiency of the screen 38 may be increased without unduly increasing the undesirable effects of large apertures on the screen.

Moreover, by spacing the large size apertures 92 a distance 96 from leading edge position 98 of screen 38, a leading edge 52 (FIG. 1) of a sheet of print media 26 may be slightly incorrectly positioned rearwardly from leading edge position 98, while still being within print position tolerances, without exposing the larger apertures 92 and thereby without reducing the vacuum efficiency of the system. The screen 38 as disclosed, therefore, may reduce both sheet cockle and media edge liftoff from the platen 14. Manufacturing screen 38 with apertures of a larger size only in leading edge region 94 also allows the screen to accommodate and hold down a variety of different sizes of sheets of print media 26 without changing out the screen 38 for different applications.

Other variations and modifications of the concepts described herein may be utilized and fall within the scope of the claims below.

We claim:

1. An imaging device, comprising:
a media receiving support surface that defines an axis of media travel; and
an array of vacuum grooves extending along said axis of media travel, each groove of said array recessed downwardly from said media receiving support surface and positioned perpendicular to said axis of media travel,
wherein individual grooves of a leading edge region of said array have a depth greater than a depth of a remainder of individual grooves of said array.

2. The device of claim 1 wherein said media receiving support surface defines a width measured perpendicular to said axis of media travel, and wherein each groove of said array defines a length less than half of said width.

3. The device of claim 1 wherein said individual grooves of said array are arranged in columns positioned along said axis of media travel, and wherein an edge region of a first column is aligned with a first standard size media edge position on said platen, and wherein an edge region of a second column is aligned with a second standard size media edge position on said platen.

4. The device of claim 1 wherein said leading edge region extends a distance of less than 50 mm from a leading edge position of said media receiving support surface.

5. The device of claim 1 wherein said depth of said individual grooves of said leading edge region is at least 2 mm, and wherein said depth of said remainder of individual grooves of said array is less than 2 mm.

6. The device of claim 1 further comprising a plurality of channels connecting individual grooves of said array, said channels extending parallel to said axis of media travel.

7. The device of claim 1 further comprising a screen covering said media receiving support surface, said screen including an array of apertures extending therethrough, said array including a leading edge region of apertures positioned rearwardly from a leading edge position of said media receiving support surface, wherein apertures in said leading edge region are larger than apertures in a remainder of said screen.

8. The device of claim 7 wherein said leading edge region of said screen is positioned rearwardly from said leading edge position of said media receiving support surface by at least 2 mm.

9. The device of claim 7 wherein a portion of said apertures in said remainder of said screen are positioned between said leading edge position and said leading edge region.

10. The device of claim 7 wherein said apertures in said leading edge region are at least two times larger than said apertures in said remainder of said screen.

11. An imaging device, comprising:
a vacuum hold down screen adapted for placement on a platen, said screen including a print media receiving surface having an array of apertures positioned therein, said array including a leading edge region positioned rearwardly at least 2 mm from a leading edge position of said screen, wherein apertures in said leading edge region are larger than apertures in a remainder of said screen.

12. The device of claim 11 further comprising a platen that supports said vacuum hold down screen, said platen including an array of recesses extending along an exterior surface of said platen, wherein said recesses in a leading edge region of said platen are deeper than recesses in a remainder of said platen.

13. The device of claim 11 further comprising a platen that supports said vacuum hold down screen, said platen including an array of recesses extending along an exterior surface of said platen, wherein said array defines a first column of recesses having an edge region aligned with a larger sheet sized media edge region on said platen, and wherein said array defines a second column of recesses having an edge region aligned with a large sized media edge region on said platen.

14. The device of claim 11 wherein said leading edge region terminates at most a distance of 20 mm from said leading edge position of said screen.

15. The device of claim 11 wherein said apertures in said leading edge region are at least two times larger than said apertures in said remainder of said screen.

16. The device of claim 12 wherein said recesses extend perpendicular to an axis of print media travel of said screen.

17. The device of claim 13 wherein said columns extend parallel to an axis of print media travel of said screen.

18. A method of securing a print media to a platen, comprising:
placing a sheet of print media on a print media support; and
providing a vacuum to an array of recesses positioned on a exterior surface of said support to hold the sheet in place on the support by vacuum pressure, wherein said array of recesses includes a plurality of recesses in a leading edge region of said support that have a depth greater than a depth of a plurality of recesses in a remaining region of said support.

19. The method of claim 18 wherein said providing a vacuum further comprises providing a vacuum pressure to said sheet through a screen positioned on said support and between said support and said sheet, said screen including a plurality of vacuum apertures in a leading edge region of said screen that have a size greater than a size of a plurality of vacuum apertures in a remaining region of said screen.

20. The method of claim 18 wherein said recesses define a plurality of columns of recesses, each column having an edge region extending parallel to an axis of travel of said sheet, and wherein ones of said plurality of columns extend along ones of standard sized sheet edge positions.

21. An imaging device, comprising:
a media receiving support surface that defines an axis of media travel; and
an array of vacuum groove columns extending along said axis of media travel, each groove of said array recessed downwardly from said media receiving support surface and positioned perpendicular to said axis of media travel, and each column of said array positioned parallel to said axis of media travel and defining a column width less than half a width of said media receiving support surface.

22. The device of claim 21 comprising at least four columns within said array.
